(19) United States
(12) Patent Application Publication
(10) Pub. No.: US 2025/0088540 A1
(43) Pub. Date: Mar. 13, 2025

(54) SYSTEMS AND METHODS TO AUTOMATE SECURITY ASSETS DISCOVERY AND ONBOARDING

(71) Applicant: Tyco Fire & Security GmbH, Neuhausen am Rheinfall (CH)

(72) Inventors: Lipphei Adam, Nolensville, TN (US); Saravanabavanandam Sadaksharam, Plano, TX (US); Jesse D. Nercessian, Allendale, NJ (US)

(21) Appl. No.: 18/827,532

(22) Filed: Sep. 6, 2024

Related U.S. Application Data
(60) Provisional application No. 63/537,395, filed on Sep. 8, 2023.

(51) Int. Cl. H04L 9/40; H04L 67/10

(52) U.S. Cl. CPC H04L 63/20; H04L 67/10

(57) ABSTRACT

A method for discovering and monitoring equipment in a building management system may include transmitting a plurality of commands on the building network, each command comprising protocol-specific subsystem criteria for a corresponding security subsystem type of a plurality of security subsystem types; receiving a plurality of responses to the plurality of commands from the security devices via the building network; identifying a plurality of security subsystems on the building network based on whether the plurality of responses contain identifying strings specified by the protocol-specific subsystem criteria for the plurality of security subsystem types; generating an asset hierarchy comprising the plurality of security subsystems identified on the building network and the security devices within each identified security subsystem; and onboarding the security devices within each identified security subsystem.

### CROSS-REFERENCE TO RELATED PATENT APPLICATION

This application claims the benefit of and priority to U.S. Provisional Patent Application No. 63/537,395, filed on Sep. 8, 2023, the entire disclosure of which is incorporated by reference herein.

### BACKGROUND

The present disclosure relates generally to building management systems. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

### SUMMARY

According to an exemplary embodiment, a method for discovering and monitoring equipment in a building management system, includes: transmitting a plurality of commands on the building network, each command comprising protocol-specific subsystem criteria for a corresponding security subsystem type of a plurality of security subsystem types; receiving a plurality of responses to the plurality of commands from the security devices via the building network; identifying a plurality of security subsystems on the building network based on whether the plurality of responses contain identifying strings specified by the protocol-specific subsystem criteria for the plurality of security subsystem types; generating an asset hierarchy comprising the plurality of security subsystems identified on the building network and the security devices within each identified security subsystem; and onboarding the security devices within each identified security subsystem.

According to another exemplary embodiment, a building management system includes: a communications bus; and a plurality of subsystems coupled to the communications bus and configured to communicate on the communications bus, wherein the plurality of subsystems each include one or more security devices configured to monitor a state or condition of a building; a cloud platform communicably coupled to the communications bus; and a first device coupled to the communications bus including a processing circuit including one or more memory devices coupled to one or more processors, the one or more memory devices configured to store instructions thereon that, when executed by the one or more processors, cause the one or more processors to: transmit a plurality of commands on the communications bus, each command comprising protocol-specific subsystem criteria for a corresponding subsystem type of a plurality of subsystem types; receive a plurality of responses to the plurality of commands from the plurality of subsystems via the communications bus; identify subsystem type from the plurality of subsystem types for each of the plurality of subsystems based on whether the plurality of responses contain identifying strings specified by the protocol-specific subsystem criteria for the plurality of security subsystem types; generate an asset hierarchy comprising the plurality of security subsystems identified o and the one or more security devices within each identified security subsystem; and onboard the security devices within each identified security subsystem.

### BRIEF DESCRIPTION OF THE DRAWINGS

FIG. 1 is drawing of a building equipped with a heating, ventilating, and air conditioning (HVAC) system, according to some embodiments.

FIG. 2 is a diagram illustrating a building management system which can be used to monitor and control building and security systems of FIG. 1, according to some embodiments.

FIG. 3 is a block diagram illustrating select components of the edge device and cloud platform of FIG. 2 in greater detail, according to some embodiments.

FIGS. 4A and 4B are partial views of a sequence diagram illustrating a security asset discovery and onboarding process which can be used by the BMS of FIG. 2 to automatically discover and interact with security equipment within the BMS, according to some embodiments.

FIG. 5 is a sequence diagram illustrating a subsystem scan process which can be used by the BMS of FIG. 2, according to some embodiments.

FIG. 6 is a sequence diagram illustrating a device scan process which can be used by the BMS of FIG. 2, according to some embodiments.

FIG. 7 is a sequence diagram illustrating a device monitoring process which can be used by the BMS of FIG. 2, according to some embodiments.

FIG. 8 is a sequence diagram illustrating select aspects of an exemplary security asset discovery and onboarding process of FIG. 2, according to some embodiments.

FIG. 9 is an example of a device category mapping which can be used to categorize devices found in the security asset discovery and onboarding process of FIG. 2, according to some embodiments.

### DETAILED DESCRIPTION

Referring generally to the FIGURES, a building management system (BMS) with automatic security asset discovery and onboarding is shown, according to some embodiments. A BMS is, in general, a system of devices configured to control, monitor, and manage equipment in or around a building or building area. A BMS can include, for example, a HVAC system, a security system, a lighting system, a fire alerting system, any other system capable of managing building functions or devices, or any combination thereof.

In brief overview, the BMS described provides a system architecture that facilitates automatic security asset discovery, onboarding, monitoring, and categorization. Security asset discovery can occur on multiple levels of the BMS across multiple different communication protocols (e.g., SNMP, ONVIF, SSDP, NMAP, WS-Discovery, etc.) and multiple different security subsystem APIs (e.g., RabbitMQ, MQTT, CCure, Exacq, System N, Genetec, Milestone, etc.) to detect security-related systems, subsystems, or devices on the BMS network. For example, security assets can be discovered without installing any agents or enabling any discoverability protocols on the security assets. In some embodiments, data for the discovered assets is retrieved which can create an asset hierarchy. In some embodiments, the discovered security assets are automatically assigned into respective categories (e.g., Access, Video, Fire, Intrusion, etc.). To maintain an updated asset hierarchy, the automatic security asset discovery process can be regularly rerun.

Subsystems and devices in the BMS present themselves to the network in different ways. In some embodiments, the security asset discovery process searches the BMS with multiple different communication protocols to identify the security subsystems on the network. By scanning across multiple different communication protocols, the security asset discovery process improves the subsystem discovery success rate even when multiple, disparate subsystems are used. For example, a CCure subsystem may be present on the network and include a first camera, and an Exacq subsystem may be present on the network and include a second camera. The CCure and Exacq subsystems may communicate with different communication protocols. Scanning across multiple protocols ensures both subsystems are discovered.

Discovered subsystems can each include multiple devices. In some embodiments, the security asset discovery process calls the APIs for each of the discovered subsystems and searches the returned data for one or more of a plurality of markers identifying security assets within the subsystems. In some embodiments, the API commands are provided on one or more ports corresponding to the discovered subsystems. In some embodiments, the scan results for each of the security subsystems are combined and provided to a cloud platform of the BMS, for monitoring and/or categorization.

### Building and HVAC System

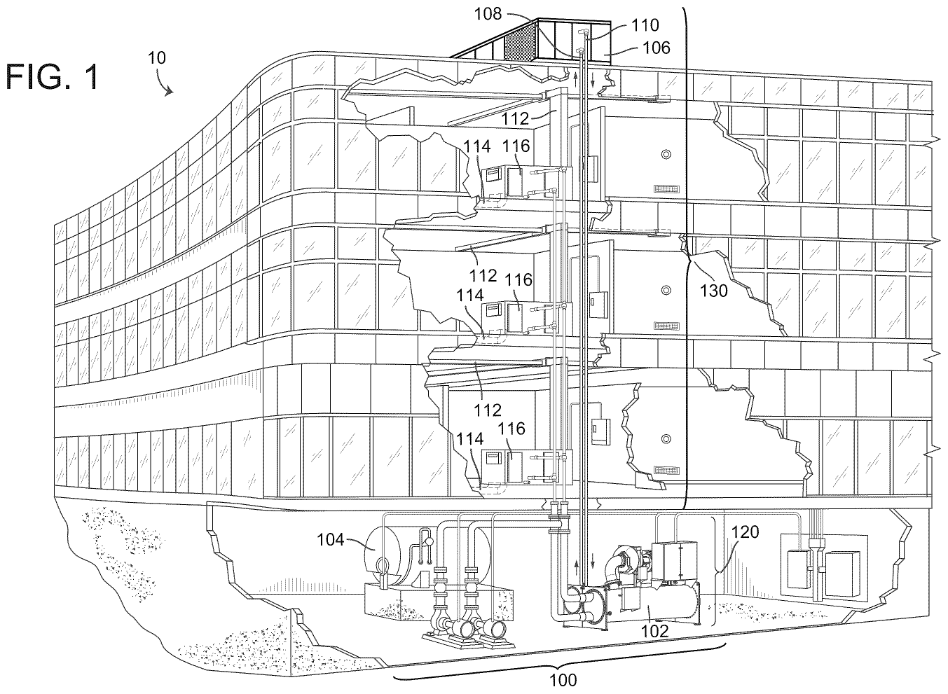

Referring now to FIG. 1, an exemplary building and HVAC system in which the systems and methods of the present invention can be implemented are shown, according to an exemplary embodiment. In FIG. 1, a perspective view of a building 10 is shown. Building 10 is served by a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

### Building Management System

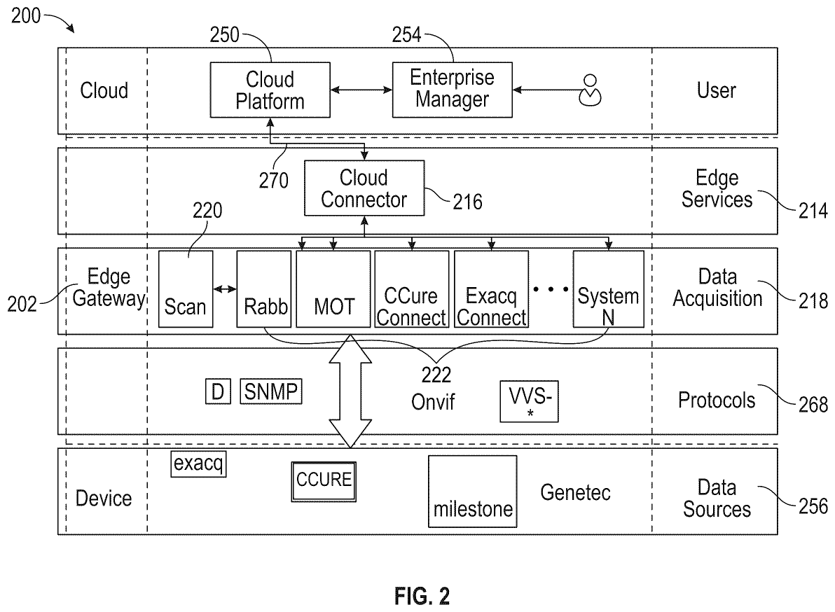

Referring now to FIG. 2, a block diagram illustrating another building management system (BMS) 200 is shown, according to an exemplary embodiment. BMS 200 may include some or all of the features of HVAC system 100, as described with reference to FIG. 1. BMS 200 is shown to include an edge device, shown as edge gateway 202, a cloud platform 250, an enterprise manager 254, and a plurality of data sources shown as security subsystems 256. In some embodiments, edge gateway 202 is connected with one or more devices of the security subsystems 256 via a system bus 266. System bus 266 can include any of a variety of communications hardware (e.g., wire, optical fiber, terminals, etc.) configured to facilitate communications between edge gateway 202 and security subsystems 256 connected to system bus 266. In some embodiments, edge gateway 202 discovers the security subsystems 256 across one or more communications protocols 268 (e.g., SNMP, ONVIF, SSDP, NMAP, WS-Discovery, etc.). Security subsystems 256 can include a plurality of different subsystems (e.g., Access, Vision, Fire, Intrusion) which can include access-related security devices such as card access systems, vision-related security devices such as cameras, fire-related security devices such as smoke detectors, fire alarms, or fire suppression systems, and intrusion-related devices such as door or window alarms, amongst others. The security subsystems 256 can belong to a unique service with a unique API. In some embodiment, edge gateway 202 includes edge data acquisition unit 218. In some embodiments, data acquisition unit 218 is configured to perform the automatic security asset discovery and onboarding process described. Data acquisition unit 218 includes a scanner 220 configured to scan each of the discovered security subsystems 256 using the connectors 222 to discover individual assets or devices on each of the security subsystems 256. The connectors 222 include a plurality of API services for each unique type of security subsystems 256 discovered. In this manner the assets can be discovered and scanned without the need to install agents and/or enable discoverability protocols on the security assets beforehand.

Edge gateway 202 can be configured to gather data from the discovered security devices within each of the security subsystems 256. The data can include IP address, MAC address, online status, firmware version, software version, model, serial number, and telemetry data such as disk space, video recording status, tamper status, license expiration, amongst other types of collected data.

Still referring to FIG. 2, edge gateway 202 can be configured to communicate with a cloud platform 250 via cloud connector 216 within edge services 214 and internet communications link 270. As previously described, BMS 200 including edge gateway 202 can automatically discover and manage security assets connected to the edge gateway 202. Edge gateway 202 can be configured to gather data from the discovered security assets and provide it to the cloud platform 250 for use by cloud applications.

Cloud platform 250 can include a variety of cloud-based services and/or applications configured to store, process, analyze, or otherwise consume the data collected from the edge gateway 202. Cloud platform 250 may be access by various users (e.g., enterprise users, mechanical contractors, cloud application users, etc.) via the enterprise manager 254. Users can interact with the cloud platform 250 via a UI provided by the cloud platform 250 or the enterprise manager 254. The features of the cloud platform 250 and the edge gateway 202 are described in greater detail below.

### Infrastructure Components

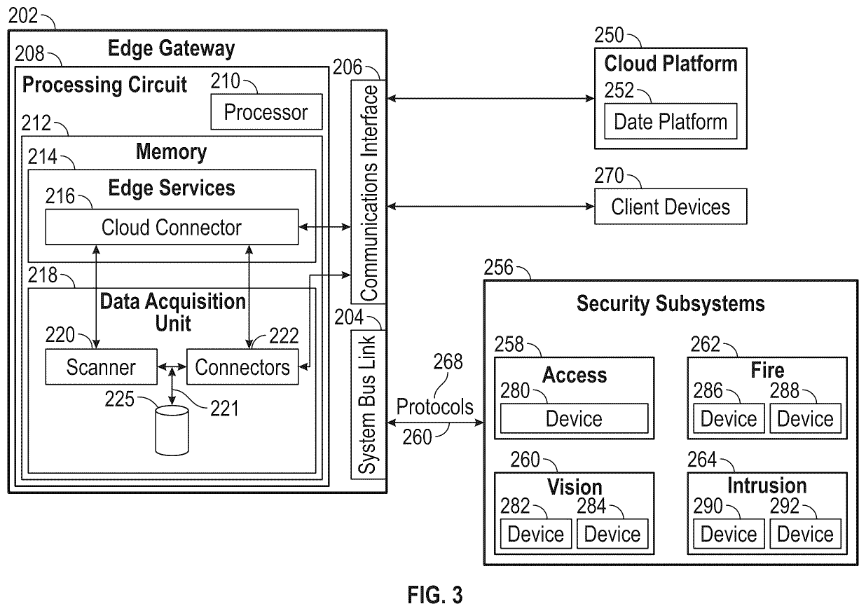

Referring to FIG. 3, a block diagram illustrating select components of the edge gateway 202 and cloud platform 250 in greater detail is shown, according to an exemplary embodiment. Edge gateway 202 is shown to include a systems bus link 204, a communications interface 206, a processing circuit 208, edge services 214, and data acquisition unit 218. Systems bus link 204 can be used by edge gateway 202 to communicated with the various security subsystems 256 across one or more protocols. Communications interface 206 can facilitate communications between edge gateway 202 and external systems, devices, or applications such as cloud platform 250 and client devices 270 (e.g., a tablet, a laptop computer, a smartphone, a desktop computer, a computer workstation, etc.), and other monitoring and reporting applications, enterprise control applications, remote systems and applications, and/or other external systems or devices for allowing user control, monitoring, and adjustment to BMS 200 and/or edge gateway 202.

Communications interface 206 can include wired or wireless communications interfaces (e.g., jacks, antennas, transmitters, receivers, transceivers, wire terminals, etc.) for conducting data communications with client device 270 or other external systems or devices. In various embodiments, communications conducted via communications interface 206 can be direct (e.g., local wired or wireless communications) or via a communications network (e.g., a WAN, the Internet, a cellular network, etc.). For example, communications interface 206 can include an Ethernet card and port for sending and receiving data via an Ethernet-based communications link or network. In another example, communications interface 206 can include a WiFi transceiver for communicating via a wireless communications network. In another example, communications interface 206 can include cellular or mobile phone communications transceivers. In one embodiment, communications interface 206 is a power line communications interface and/or an Ethernet interface.

Processing circuit 208 is shown to include a processor 210 and memory 212. Processor 210 can be a general purpose or specific purpose processor, an application specific integrated circuit (ASIC), one or more field programmable gate arrays (FPGAs), a group of processing components, or other suitable processing components. Processor 210 is configured to execute computer code or instructions stored in memory 212 or received from other computer readable media (e.g., CDROM, network storage, a remote server, etc.).

Memory 212 can include one or more devices (e.g., memory units, memory devices, storage devices, etc.) for storing data and/or computer code for completing and/or facilitating the various processes described in the present disclosure. Memory 212 can include random access memory (RAM), read-only memory (ROM), hard drive storage, temporary storage, non-Coe memory, flash memory, optical memory, or any other suitable memory for storing software objects and/or computer instructions. Memory 212 can include database components, object code components, script components, or any other type of information structure for supporting the various activities and information structures described in the present disclosure. Memory 212 can be communicably connected to processor 210 via processing circuit 208 and can include computer code for executing (e.g., by processor 210) one or more processes described herein. When processor 210 executes instructions stored in memory 212, processor 210 generally configures edge gateway 202 (and more particularly processing circuit 208) to complete such activities.

Still referring to FIG. 3, edge gateway 202 is shown to include edge services 214. Edge services 214 include cloud connector 216 configured to communicate with the cloud platform 250 via the communications interface 206. Cloud connector 216 can interface with both data acquisition unit 218 and cloud platform 250. Cloud connector 216 can translate edge gateway concepts into cloud concepts to allow edge gateway 202 to communicate with cloud platform 250. Cloud connector 216 can also translate cloud concepts into edge gateway concepts to allow data from cloud platform 250 to be received and processed by the edge gateway 202.

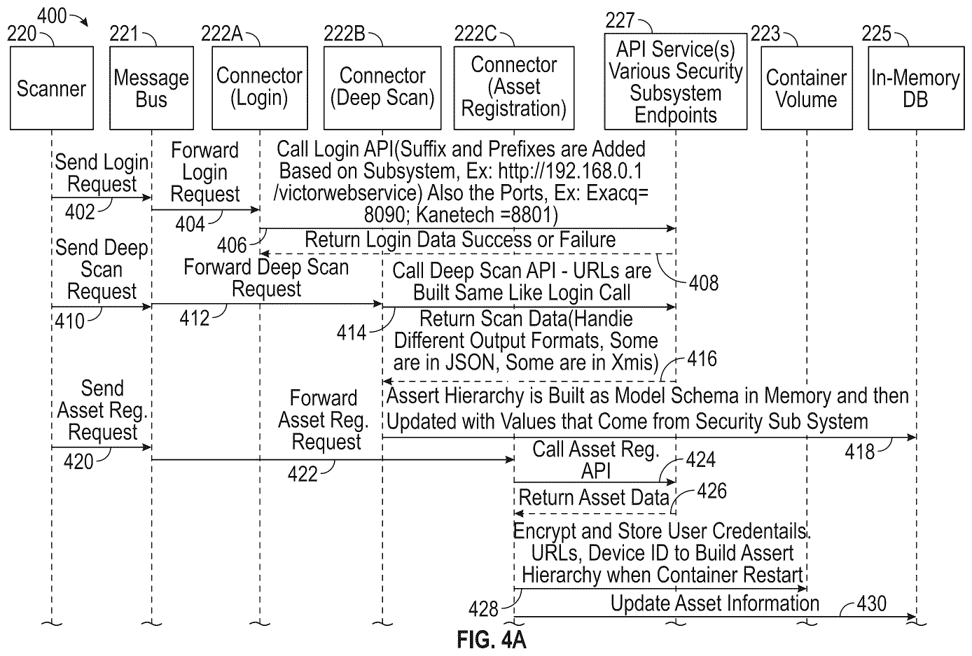

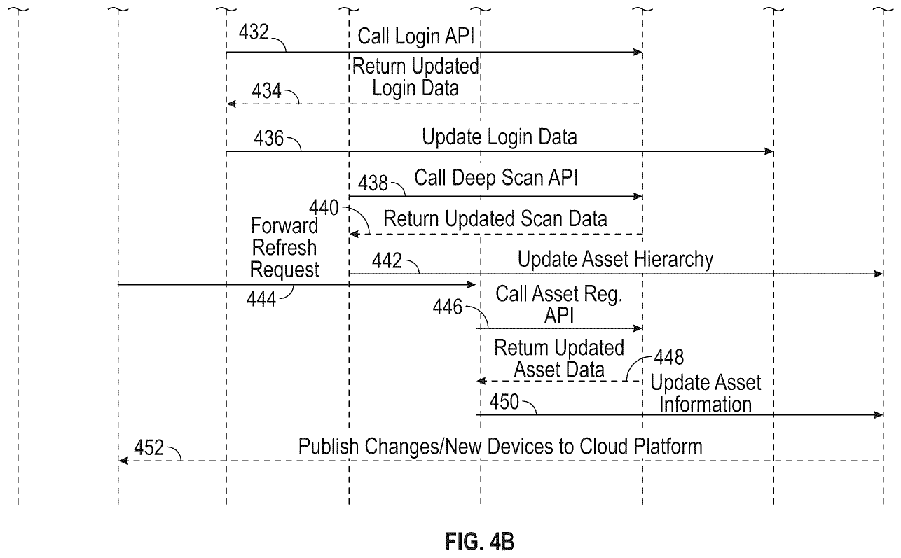

Data acquisition unit 218 can be configured to perform the security asset discovery, onboarding, and monitoring operations described with reference to FIG. 2 and described in greater detail below with reference to FIGS. 4-9. Data acquisition unit 218 is shown include scanner 220 and connectors 222. Scanner 220 can be configured to perform a subsystem scan which scans the network within the BMS 200 for one or more security subsystems 256 one or more security protocols 268 (e.g., SNMP, ONVIF, SSDP, NMAP, WS-Discovery, etc.). The security subsystems 256 can include an access subsystem 258, a vision subsystem 260, a fire subsystem 262, and an intrusion subsystem 264, amongst other subsystems. One or more of the security subsystems 256 may belong to a unique security service that relies on one or more of the security protocols 268. The scanner 220 of edge gateway 202 can be configured to scan the system bus 266 of the BMS 200 using the multiple security protocols 268 to provide a substantially protocol-agnostic security subsystem 256 discovery process, which can discover one or more security subsystems 256 using one or more security protocols 268.

Edge gateway 202 can discover security assets and devices within the security subsystems 256. Security subsystems 256 includes one or more devices, shown as device 280 of access subsystem 258, device 282 and device 284 of vision subsystem 260, device 286 and device 288 of fire subsystem 262, and device 290 and 292 of intrusion subsystem 264. Scanner 220 is configured to perform a device scan to discover each of the devices 280-292 within the discovered security subsystems 256 using the connectors 222 corresponding to the discovered security subsystems 256. Performing the device scan after the subsystem scan and on the discovered security subsystems 256 can reduce the network bandwidth and computational power required to perform the discovery process by reducing the pool of security services and unique APIs (e.g., connectors 222) that must be called to those that are discovered in the BMS 200, improving both its efficiency and speed. In some embodiments, the security service APIs for undiscovered security services are ignored, and only the APIs (e.g., connectors 222) that are part of the discovered security subsystems 256 are called. Connectors 222 can include one or more connectors for APIs of the various discovered subsystems. As described above, the various discovered subsystems may require a number of different connectors (e.g., RabbitMQ, MQTT, CCure, Exacq, System N, etc.)

Edge gateway 202 to subscribe to and monitor select devices of the devices 280-292 using a device monitor process. In some embodiments, edge gateway 202 receives list of selected devices for monitoring from the enterprise manager 254. The scanner 220 is configured to collect the data for the selected devices using the connectors 222 and return the data to the enterprise manager 254 via the cloud connector 216. The selected devices may be at least one of the devices 280-292. For example, devices 282-292 may be selected, but device 280 may not. The scanner 220 is thereafter configured to obtain the data (e.g., status data, telemetry data, etc.) for the selected devices (e.g., devices 282-290). The data can be presented to user via the enterprise manager 254 and the client devices 270.

### Cloud Platform

Referring still to FIG. 3, cloud platform 250 is shown to include a data platform 252. In some embodiments, data platform 252 is configured to receive, store, process, and provide the data collected by the edge gateway 202 regarding the security subsystems 256 and included device within the BMS 200. Data platform 252 can include one or more services, applications or modules, such as a dictionary service, a data adapter, and one or more cloud applications. For example, a dictionary service can be configured to lookup text strings that correspond to enumerated values. Enumerated values can be included in status messages received from edge gateway 202 and may be specified as a combination of an enumerated set and an enumerated value. Dictionary service can use the set and value combination to retrieve a string message that corresponds to the set and value combination.

The data platform 252 can be configured to receive and translate incoming data messages provided by the edge gateway 202. In some embodiments, a data adaptor of data platform 252 performs various data transformations and other functions specific to edge gateway 202. For example, a data adaptor of data platform 252 can be configured to create entities for data platform 252 based on an asset hierarchy and/or discovered device list provided by edge gateway 202. A data adaptor of data platform 252 can provide plug & play functionality for Data platform 252 by automatically determining which values need timeseries data. A data adaptor of data platform 252 can automatically update the “shadow” for edge gateway to request values for these timeseries data.

Data platform 252 can store the asset hierarchy sent by edge gateway 202. In some embodiments, data platform 252 uses the asset hierarchy and device data provided by edge gateway 202 to extract system information, points, and create a device-system-point hierarchy. Data platform 252 can store such data in cloud platform 250. Data platform 252 can create reported points of selected devices and get bound points for the selected systems and can update bound points in the device's shadow. Data platform 252 can generate a point ID, system ID, timeseries ID, point FOR mapping for points, and system FOR mapping for systems and can store such data within cloud platform 250. Data platform 252 can extract schedule information and create/update device-system-point-schedule information. Data platform 252 can extract and store a system ID to alarm timeseries ID mapping.

The data platform 252 can include any variety of cloud applications configured to use the data provided to the cloud platform 250 by the edge gateway 202. For example, cloud applications can include an energy management application, monitoring and reporting applications, an enterprise control application, or other cloud-based applications. In some embodiments, cloud applications exist as a separate layer of cloud platform 250 (i.e., separate from data platform 252). This allows cloud applications to be isolated from the details of how the data from edge gateway are collected. In other embodiments, cloud applications can exist as remote applications that run on remote systems or devices. Cloud applications can use the data provided by edge gateway 202 to perform a variety data visualization, monitoring, and/or control activities. For example, cloud applications can include an energy management application and/or a monitoring and reporting application configured to generate user interfaces (e.g., charts, graphs, etc.) that present the data to a user. In some embodiments, the user interfaces present timeseries data at a variety of different levels of granularity (e.g., hourly, weekly, monthly, etc.) in a single chart or graph. For example, a dropdown selector can be provided to allow a user to select a particular level of granularity for a particular timeseries. Several examples of user interfaces that can be generated based on timeseries data are described in U.S. patent application Ser. No. 15/182,579 filed Jun. 14, 2016, and U.S. Provisional Patent Application No. 62/446,284 filed Jan. 13, 2017. The entire disclosures of both these patent applications are incorporated by reference herein.

In some embodiments, cloud applications include an enterprise control application configured to use the data provided by edge gateway 202 to perform various control activities. For example, the enterprise control application can use timeseries data as input to a control algorithm (e.g., a state-based algorithm, an extremum seeking control (ESC) algorithm, a proportional-integral (PI) control algorithm, a proportional-integral-derivative (PID) control algorithm, a model predictive control (MPC) algorithm, a feedback control algorithm, etc.) to generate control signals for edge gateway 202. In some embodiments, edge gateway 202 uses the control signals to operate building equipment or security devices (e.g., chiller 102 or device 286). Operating the devices can affect the measured or calculated or retrieved values of the data provided by edge gateway 202. Accordingly, the enterprise control application can use the timeseries data as feedback to control the equipment of BMS 200.

Data platform 252 can include a variety of services (e.g., APIs) configured to process, store, analyze, and perform other operations on the data provided by edge gateway 202. For example, Data platform 252 can include an identity management service, a security service, a timeseries service, an analytics service, a command and control service, a time synchronization service, an asset service, an entity service and/or other types of data platform services. Several examples of a data platform which can be used as data platform 252 are described in detail in U.S. Provisional Patent Application No. 62/564,247 filed Sep. 27, 2017, U.S. Provisional Patent Application No. 62/457,654 filed Feb. 10, 2017, U.S. patent application Ser. No. 15/644,519 filed Jul. 7, 2017, U.S. patent application Ser. No. 15/644,560 filed Jul. 7, 2017, and U.S. patent application Ser. No. 15/644,581 filed Jul. 7, 2017. The entire disclosure of each of these patent applications is incorporated by reference herein. Examples of a cloud platform which can be used as a cloud platform 250 are described in detail in U.S. patent application Ser. No. 16/153,531, filed Oct. 5, 2018, the entire disclosure of which is incorporated by reference herein.

### Security Asset Discovery and Onboarding Process

Referring now to FIGS. 4A and 4B, a sequence diagram illustrating a security asset discovery and onboarding process is shown as process 400, according to an exemplary embodiment. Process 400 can be performed by one or more components of BMS 200 to discover, subscribe to, and monitor security assets and devices from one or more subsystems using one or more protocols on the network (e.g., system bus 266) within the BMS 200. For example, process 400 can be performed by edge gateway 202.

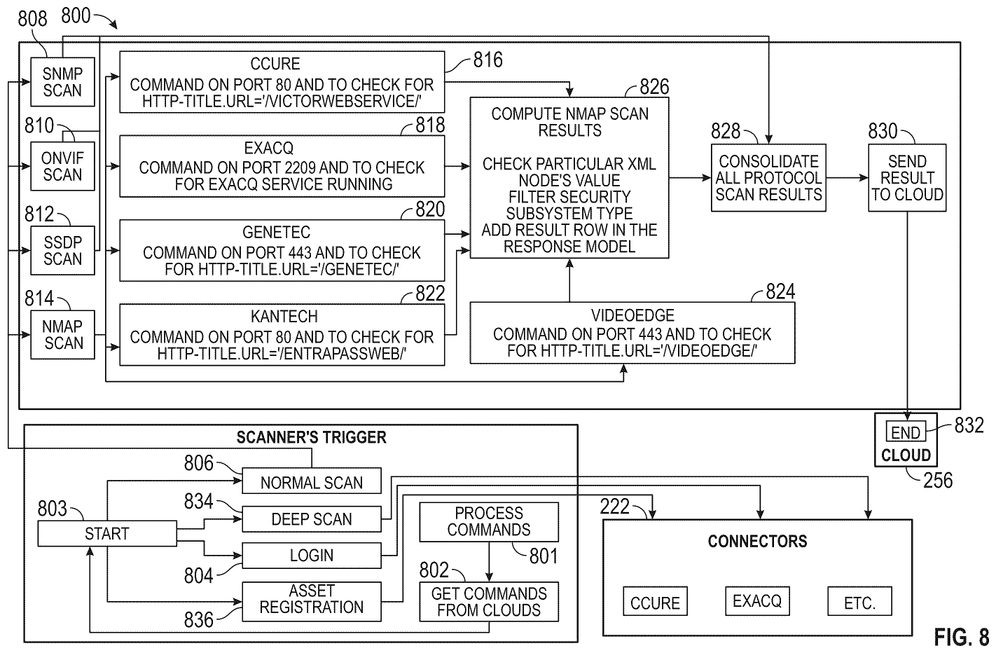

In some embodiments, the process 400 includes identifying a plurality of protocols being used within the building network of the BMS 200 (i.e., also referred to herein and in the figures as a normal scan or a protocol scan) and then logging into performing a deep scan using each discovered protocol to discovery one or more subsystems and one or more devices on each subsystem. The normal scan or the protocol scan for determining the protocols used in the BMS 200 is discussed in further detail below with reference to FIG. 8.

Referring still to FIGS. 4A and 4B, process 400 may be performed after the protocol scan is performed. In other embodiments, process 400 may include as part of the log in a protocol scan to identify the active or used protocols in the BMS 200. Still in other embodiments, the process 400 may be performed before a protocol scan. Process 400 is shown to include scanner 220 sending a login request to on to system bus 266 (step 402). In some embodiments, message bus 221 corresponds to the interface communication systems between scanner 220 and connector 222. The login request may include credentials identifying a user and the user's permitted access level. For example, a login request may be structured in JSON similar to the request below:

```
{
  “discoveryType”: “login”,
  “sourceGroupId”: “de08ccbe-01a7-49cd-b7cd-dfaf801efcfc”,
  “devices”: [
    {
      “subsystem”: “ccure ”,
      “ip”: “192.168.77.145”,
        “pw”: “”,
      “un”: “”,
“SubDeviceIds”: [“6755628e-ae2f-4af8-964e-9153172c77f8”]
    }
  ]
```

In the exemplary login request above, the value of the field discovery Type is “login” indicating that the request is a login request. The value of the field sourceGroupId is a unique identifier identifying the source of one or more devices of the login request. The value of the subsystem type is shown as “ccure” but may be any of the subsystems that are present in the BMS 200 (e.g., Ccure, Exacq, Genetec, etc.). The IP address is the IP address, or in some cases a range of IP addresses, of the devices in the group. The PW field, while shown as empty above, is filled with the password and the UN field, while shown as empty above, is filled with the username. The SubDeviceIds field can include one or more identifiers for subdevices associated with a given device.

The message bus 221 can forward the login request to connector (login) 222a. In some embodiments, connector (login) 222a is one of the connectors 222 of the data acquisition unit 218 (step 404). Connector (login) 222a can call a login API using API services 227. In some embodiments, API services 227 are performed by the edge gateway 202. For example, the memory 212 of the edge gateway 202 can include API services 227 coupled to the scanner 220 and the connectors 222. The API services 227 can include APIs for each of a plurality of security subsystem types (e.g., Ccure, Genetech, Kantech, Exacq, and VideoEdge). Suffix prefixes can be added based on subsystem type. In some embodiments, multiple subsystem with a plurality of subsystem types may be present in the BMS 200 and/or desired by a user to be identified. Multiple suffixes and prefixes can be added for each subsystem type. The suffixes and prefixes can be stored in the in-memory DB 225 of edge gateway 202 or in the cloud platform 250. Each subsystem may communicate to devices on the subsystem using one or more protocols or security protocols (i.e., SNMP, Onvif, SSDP, NMAP, etc.) and the suffixes and prefixes can be part of a protocol-specific subsystem criteria that can identify and/or communicate with each subsystem according to the appropriate protocol. Each security protocol 268 may include a plurality of protocol-specific subsystem criteria, such as one protocol-specific subsystem criteria for each subsystem type that is present or desired to be checked. The protocol-specific subsystem criteria for a given subsystem type can include an identifying string such as the suffices or prefixes associated with said subsystem type. The identifying string can be added to the login call. The connector 222a may also add network ports unique to each subsystem type. For example, if Exacq and Kanetech subsystems are desired to be searched for, unique ports for each subsystem can be included, such as Exac1=8090 and Kanetech=8801. The network ports serve as a virtual endpoint for facilitating data communication between the security subsystems 256 and the edge gateway 202 in a networked environment. Network ports enable various services and applications to share a common network infrastructure, and each security subsystem type (e.g., Genentech, Ccure, etc.) can have a unique network port associated with it as part of its protocol-specific subsystem criteria. For example, the NMAP protocol-specific subsystem criteria for a Genentech-type subsystem may have a unique network port 443 and an identifying string in the URL “Genetec,” the NMAP protocol-specific subsystem criteria for a Kantech-type subsystem may have a unique network port 443 and include the identifying string in the URL “VideoEdge,” while the SSDP protocol-specific subsystem criteria for a Kantech-type subsystem may have another unique network port and identifying string. Still in some embodiments, the protocol-specific subsystem criteria are the same for each subsystem, no matter the security protocol 268 used. In summary, there may be a plurality of security protocols 268 which the login call is sent with and to in order to determine if the security protocol 268 is used in the BMS 200 and to login to each security protocol used in the BMS 200. Each one of the plurality of security protocols is itself associated with a plurality of protocol-specific subsystem criteria. For example, for the NMAP security protocol there can be protocol-specific subsystem criteria for CCure, Exacq, Genetec, Kantech, and Video Edge-type subsystems. For the SSDP security protocol, there can also be another, different set of protocol-specific subsystem criteria for CCure, Exacq, Genetec, Kantech, and Video Edge-type subsystems. Each protocol-specific subsystem criteria can contain one or more identifying markers, such as a unique network port and an identifying string for that security protocol and that subsystem-type. In some embodiments, one or more protocol-specific subsystem criteria have the same network port or the same identifying string.

API services 227 can return to connector (login) 222a login data indicating if the login was a success or a failure (step 408). For example, the login data returned to the connector may be structured in JSON similar to the login response below:

```
  “eventDetails”: {
    “body”: {
      “devices”: [
        {
          “ip”: “192.168.77.73:8090”,
          “pw”: “”,
          “un”: “”,
          “subsystem”: “ExacqVision”
        }
      ],
      “discoveryType”: “login”,
      “sourceGroupId”: “de08ccbe-01a7-49cd-b7cd-dfaf801efcfc”,
      “transactionId”: “01ea2cc8-03ee-4979-97a5-9387d9439827”
    },
    “status”: “Success”,
    “message”:
“[{\“systemId\”:\“d89715599a2294301895869cc38aaf616640d716
66becaad2288f6539c0205af\”,\“parentId\”:null,\“name\”:\“ExacqV
ision-Server-
192.168.77.73:8090\”,\“manufacturer\”:\“ExacqVision\”,\“model\”:
\“ExacqVision-
Server\”,\“ipAddress\”:\“192.168.77.73:8090\”,\“macAddress\”:nul
l,\“category\”:null,\“subCategory\”:\“ExacqVision
Server\”,\“status\”:\“success\”,\“comments\”:\“Login
Success.\”,\“publicKey\”:\“\”,\“subDevices\”:[ ],\“id\”:null,\“account
\”:null,\“classType\”:\“ScannerResponseModel\”,\“idProperty\”:\“I
d\”}]”,
    “assetIds”: [
      “b1e1f4d4-39a5-4e1f-8ad9-b5e92b7c89e9”
    ],
    “failures”: null,
    “assetType”: “JCI.ScannerServer.1.0.0”,
    “assetNames”: [
      “Scanner”
    ]
```

The above example login response is in response to a login request for an Exacq Vision subsystem as identified in the subsystem field. The value of the transactionId field is a unique identifier for the login request/response transaction on the network. The value of the status field indicates if the login was a success or failure. In the example above, the status is success. The value of the message field includes a log describing the result of the login request, including details of the one or more devices on the subsystem that have been logged into. These details may include a systemId, which is a unique identifier of the system, a parentId, which is shown as null or empty but may include a unique identifier of a parent system to the system, a name associated with the systemId, (i.e., ExacqVision-Server, an ipAddress associated with the systemId, a manufacturer (i.e., ExacqVision), a model (i.e., ExacqVision-Server), a macAddress, a category (e.g., access, fire security, etc.), a subcategory (i.e., Exacq VisionServer, a status (i.e., Success), a publicKey if present, any subdvices connected to the systemID, an account associated with the systemId, a classType (i.e., ScannerResponseModel), a list of associated assetIds, whether there were any failures, the assetType (i.e., JCIScannerServer.1.0.0) and the asset name (i.e., Scanner).

In some embodiments, the process 400 includes identifying one or more security devices within each of the plurality of security subsystems 256 (referred to herein and in the figures as a deep scan). Scanner 220 can send a deep scan request onto the message bus 221 (step 410). The deep scan request may be similar in structure to the login request, but with the value of the discoveryType field set to deep or deepscan indicating the event is a deep scan request. For example, the deep scan request may be structured in JSON similar to the exemplary request below:

```
{
  “discoveryType”: “deep”,
  “sourceGroupId”: “de08ccbe-01a7-49cd-b7cd-dfaf801efcfc”,
  “devices”: [
    {
      “subsystem”: “genetec”,
      “ip”: “192.168.77.145”,
        “pw”: “”,
      “un”: “”,
“SubDeviceIds”: [“6755628e-ae2f-4af8-964e-9153172c77f8”]
    }
  ]
```

The deep scan request can include one or more subsystems in the subsystem field, either selected automatically or by a user from a list of subsystem types to scan. In some embodiments, the deep scan request results in identifying the one or more security devices within each identified security subsystem 256 in the BMS 200. The message bus 221 can forward the deep scan request to connector (deep scan) 222b (step 412). Connector (deep scan) 222b can call the deep scan API with URLs built in the same fashion as the login call using the API services 227 (step 414) based on the requested subsystems. The API services 227 can run API requests for each subsystem to identify the one or more security devices within the subsystem according to its own respective API. The API services 227 then return scan data to the connector (deep scan) 222b, which can come from the various subsystem-specific APIS in various output formats such as JSON or Xmls (step 416). For example, the return scan data in response to the deep scan request may be structured in JSON similar to the exemplary request below:

```
  “eventDetails”: {
    “body”: {
      “devices”: [
        {
          “ip”: “192.168.77.73:8090”,
          “pw”: “ ”,
          “un”: “ ”,
          “subsystem”: “ExacqVision”
        }
      ],
      “discoveryType”: “deep”,
      “sourceGroupId”: “de08ccbe-01a7-49cd-b7cd-dfaf801efcfc”,
      “transactionId”: “0b221f22-dbce-4307-886a-9fab8a5cebb1”
    },
    “status”: “Success”,
    “message”:
“[{\“systemId\”:\“d89715599a2294301895869cc38aaf616640d716
66becaad2288f6539c0205af\”,\“parentId\”:null,\“name\”:\“ExacqV
ision-Server-
192.168.77.73:8090\”,\“manufacturer\”:\“ExacqVision\”,\“model\”:
\“ExacqVision-
Server\”,\“ipAddress\”:\“192.168.77.73:8090\”,\“macAddress\”:nul
l,\“category\”:null,\“subCategory\”:\“ExacqVision
Server\”,\“status\”:\“success\”,\“comments\”:null,\“publicKey\”:\“\”
,\“subDevices\”:[{\“systemId\”:\“eed674aa46afe31ffcc3b41c7cbff2
56cf36a19da1a77bc21f787b29296df281\”,\“parentId\”:\“d8971559
9a2294301895869cc38aaf616640d71666becaad2288f6539c0205af
\”,\“name\”:\“AXIS VAPIX M3045-
V\”,\“manufacturer\”:\“ExacqVision\”,\“model\”:\“ExacqVision-
Device\”,\“ipAddress\”:null,\“macAddress\”:null,\“category\”:null,\
“subCategory\”:\“ExacqVision
Device\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“b70530
88336741ad67beb93e707b1a8ba9035b4098564ffc62a107e0cf42b3
26\”,\“parentId\”:\“d89715599a2294301895869cc38aaf616640d71
666becaad2288f6539c0205af\”,\“name\”:\“Hanwha Vision XNO-
L6080R\”,\“manufacturer\”:\“ExacqVision\”,\“model\”:\“ExacqVisi
on-
Device\”,\“ipAddress\”:null,\“macAddress\”:null,\“category\”:null,\
“subCategory\”:\“ExacqVision
Device\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“25463c
41fc54f0aee3b5f18db5755f6d689a2f92445d71b11d74f4c969b3ee
0b\”,\“parentId\”:\“d89715599a2294301895869cc38aaf616640d71
666becaad2288f6539c0205af\”,\“name\”:\“Dahua
N44CG53\”,\“manufacturer\”:\“ExacqVision\”,\“model\”:\“ExacqV
ision-
Device\”,\“ipAddress\”:null,\“macAddress\”:null,\“category\”:null,\
“subCategory\”:\“ExacqVision
Device\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“2f89d6
df7c646fa77be0810237b204a467b92e2590c8ccecc158c65340bf45
7a\”,\“parentId\”:\“d89715599a2294301895869cc38aaf616640d71
666becaad2288f6539c0205af\”,\“name\”:\“Illustra Essentials
IES02D1OCWIYB\”,\“manufacturer\”:\“ExacqVision\”,\“model\”:\
“ExacqVision-
Device\”,\“ipAddress\”:null,\“macAddress\”:null,\“category\”:null,\
“subCategory\”:\“ExacqVision
Device\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“3c3c01
05695e208dec6941eddecbe6a5ff3b1321f15f7646711e67efdc6d50
29\”,\“parentId\”:\“d89715599a2294301895869cc38aaf616640d71
666becaad2288f6539c0205af\”,\“name\”:\“Dahua DH-SD22204T-
GN\”,\“manufacturer\”:\“ExacqVision\”,\“model\”:\“ExacqVision-
Device\”,\“ipAddress\”:null,\“macAddress\”:null,\“category\”:null,\
“subCategory\”:\“ExacqVision
Device\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“14a1cb
0e7557d37591c9800bed64d64e3eda399481440f616acaa4bad3af1f
1e\”,\“parentId\”:\“d89715599a2294301895869cc38aaf616640d71
666becaad2288f6539c0205af\”,\“name\”:\“Dahua DH-
PTZ12248V-IRB-
N\”,\“manufacturer\”:\“ExacqVision\”,\“model\”:\“ExacqVision-
Device\”,\“ipAddress\”:null,\“macAddress\”:null,\“category\”:null,\
“subCategory\”:\“ExacqVision
Device\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“311303
cb2d778cc48e51c809f6dff1f6f004aa99c35ee2263707a3472b8e355
6\”,\“parentId\”:\“d89715599a2294301895869cc38aaf616640d716
66becaad2288f6539c0205af\”,\“name\”:\“AXIS M3045-
V\”,\“manufacturer\”:\“ExacqVision\”,\“model\”:\“ExacqVision-
Camera\”,\“ipAddress\”:null,\“macAddress\”:null,\“category\”:null,
\“subCategory\”:\“ExacqVision
Camera\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“ee71df
68648bbd1314bdeb0b9b8cc859954a6f683956fb6458c389d51c85e
aa7\”,\“parentId\”:\“d89715599a2294301895869cc38aaf616640d7
1666becaad2288f6539c0205af\”,\“name\”:\“XNO-
L6080R\”,\“manufacturer\”:\“ExacqVision\”,\“model\”:\“ExacqVisi
on-
Camera\”,\“ipAddress\”:null,\“macAddress\”:null,\“category\”:null,
\“subCategory\”:\“ExacqVision
Camera\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“0fa84d
bb95f9fffa55d6f4b44b62d37c3c24dbc4855eb678ccd594a8b3356d
df\”,\“parentId\”:\“d89715599a2294301895869cc38aaf616640d716
66becaad2288f6539c0205af\”,\“name\”:\“camera
1\”,\“manufacturer\”:\“ExacqVision\”,\“model\”:\“ExacqVision-
Camera\”,\“ipAddress\”:null,\“macAddress\”:null,\“category\”:null,
\“subCategory\”:\“ExacqVision
Camera\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“ec160d
859120bccebb1fb1bbdd3981e351f425c0fce69432c8a8f671b84b04
c7\”,\“parentId\”:\“d89715599a2294301895869cc38aaf616640d71
666becaad2288f6539c0205af\”,\“name\”:\“camera
2\”,\“manufacturer\”:\“ExacqVision\”,\“model\”:\“ExacqVision-
Camera\”,\“ipAddress\”:null,\“macAddress\”:null,\“category\”:null,
\“subCategory\”:\“ExacqVision
Camera\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“727b45
1289647bfdcfa22bbbe730a45ad2d09b829891a7e726e071d9b642c
b85\”,\“parentId\”:\“d89715599a2294301895869cc38aaf616640d7
1666becaad2288f6539c0205af\”,\“name\”:\“camera
3\”,\“manufacturer\”:\“ExacqVision\”,\“model\”:\“ExacqVision-
Camera\”,\“ipAddress\”:null,\“macAddress\”:null,\“category\”:null,
\“subCategory\”:\“ExacqVision
Camera\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“9aa439
6e944f728bff4ce8a4799e83eba3e15063c9e5ed4e5e962817046d39
f3\”,\“parentId\”:\“d89715599a2294301895869cc38aaf616640d716
66becaad2288f6539c0205af\”,\“name\”:\“Input
1\”,\“manufacturer\”:\“ExacqVision\”,\“model\”:\“ExacqVision-
Camera\”,\“ipAddress\”:null,\“macAddress\”:null,\“category\”:null,
\“subCategory\”:\“ExacqVision
Camera\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”}],\“id\”:null,\“account\”:
null,\“classType\”:\“ScannerResponseModel\”,\“idProperty\”:\“Id\”
}]”,
    “assetIds”: [
      “b1e1f4d4-39a5-4e1f-8ad9-b5e92b7c89e9”
    ],
    “failures”: null,
    “assetType”: “JCI.ScannerServer.1.0.0”,
    “assetNames”: [
      “Scanner”
    ],
```

In the above example, the subsystem to be searched for the deep scan is the Exacq Vision subsystem identified in the subsystem field. The contents of the message includes a log of devices discovered on the Exacq Vision subsystem as a result of the deep scan. The deep scan may use one or more connectors such as connector 222b to discover devices and sub devices on the identified subsystem, using the API associated with the subsystem. As shown in the above example, the message includes a number of devices including a Exacq Vision-Server with a systemId of “d89715599a2294301895869cc38aaf616640d71666becaad2288f6539c0205af” and no parentId. In the sub devices field of the Exacq Vision-Server a plurality of subdevices such as AXIS VAPIX M3045-V, Hanwha Vision XNO-L6080R, Dahua N44CG53, Illustra Essentials IES02D1OCWIYB, Dahua DH-SD22204T-GN, Dahua DH-PTZ12248V-IRB-N, AXIS M3045-V, XNO-L6080R, camera 1, camera 2, etc. As shown in the example above, for each subdevice the value of the parentId field is equal to the value of the systemId of the parent device (i.e., the Exacq Vision-Server). And while the devices may have different names, one or more of the identified devices may have the same manufacturer, or model, or category, or subcategory within the Exacq Vision subsystem.

In some embodiments, the process 400 includes generating an asset hierarchy based on the identified one or more security devices and the identified security subsystems. The connector (deep scan) 222b can build an asset hierarchy as Model Schema in database (DB) 225 of memory 212 and then update the asset hierarchy with values that from each security subsystems 256 that is identified by the API services 227 (step 418). The asset hierarchy may comprise a tree of the identified security devices for each of the security subsystems 256. In some embodiments, the asset hierarchy is provided to cloud platform 250.

In some embodiments, the process 400 includes receiving, a selection comprising at least a subset of the identified one or more security devices in the asset hierarchy, obtaining device data for the subset of the identified one or more security devices, and providing the device date to the data platform. This process may be referred to as a registration process. In some embodiments, the selection is provided in an asset registration request sent by the scanner. Process 400 is shown to include scanner 220 sending an asset registration request to the message bus 221 (step 420). The message bus 221 forwards the asset registration request to the connector (asset registration) 222c (step 422). The asset registration request may be similar in structure to the login request, but with the value of the discoveryType field set to registration indicating the event is a request to register one or more devices. The asset registration request may identify the assets (i.e., devices, subdevices) that are to be registered by systemld or subDeviceId. For example, the asset registration request may be structured in JSON similar to the exemplary request below:

```
{
  “discoveryType”: “registration”,
  “sourceGroupId”: “de08ccbe-01a7-49cd-b7cd-dfaf801efcfc”,
  “devices”: [
    {
      “subsystem”: “genetec”,
      “ip”: “192.168.77.145”,
      “pw”: “ ”,
      “un”: “ ”,
“SubDeviceIds”: [“6755628e-ae2f-4af8-964e-9153172c77f8”]
    }
  ]
```

In some embodiments, the connector (asset registration) 222c is one of the connectors 222 of edge gateway 202. The connector (asset registration) 222c can call the asset registration API from API services 227 (step 424). The API services 227 can return the asset data to the connector (asset registration) 222c (step 426). For example, the registration response (i.e., the returned data) request may be structured in JSON similar to the exemplary request below, which may or may not be in response to the example request provided above:

```
  “eventDetails”: {
    “body”: {
      “devices”: [
        {
          “ip”: “192.168.77.73:8090”,
          “pw”: “=”,
          “un”: “ ”,
          “subsystem”: “exacqvision”,
          “subDeviceIds”: [
            “d89715599a2294301895869cc38aaf616640d71666beca
ad2288f6539c0205af”,
            “0fa84dbb95f9fffa55d6f4b44b62d37c3c24dbc4855eb67
8ccd594a8b3356ddf”,
            “14a1cb0e7557d37591c9800bed64d64e3eda399481440f
616acaa4bad3af1f1e”
          ]
        }
      ],
      “discoveryType”: “registration”,
      “sourceGroupId”: “de08ccbe-01a7-49cd-b7cd-dfaf801efcfc”,
      “transactionId”: “7ae39e4a-d0fd-4fbc-ac7b-5fae2ce56efc”
    },
    “status”: “Success”,
    “message”:
“[{\“systemId\”:\“d89715599a2294301895869cc38aaf616640d716
66becaad2288f6539c0205af\”,\“parentId\”:null,\“name\”:\“ExacqV
ision-Server-
192.168.77.73:8090\”,\“manufacturer\”:\“ExacqVision\”,\“model\”:
\“ExacqVision-
Server\”,\“ipAddress\”:\“192.168.77.73:8090\”,\“macAddress\”:nul
l,\“category\”:null,\“subCategory\”:\“ExacqVision
Server\”,\“status\”:\“success\”,\“comments\”:null,\“publicKey\”:\“\”
,\“subDevices\”:[{\“systemId\”:\“14a1cb0e7557d37591c9800bed64
d64e3eda399481440f616acaa4bad3af1f1e\”,\“parentId\”:\“d89715
599a2294301895869cc38aaf616640d71666becaad2288f6539c020
5af\”,\“name\”:\“Dahua DH-PTZ12248V-IRB-
N\”,\“manufacturer\”:\“ExacqVision\”,\“model\”:\“ExacqVision-
Device\”,\“ipAddress\”:null,\“macAddress\”:null,\“category\”:null,\
“subCategory\”:\“ExacqVision
Device\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”},{\“systemId\”:\“0fa84d
bb95f9fffa55d6f4b44b62d37c3c24dbc4855eb678ccd594a8b3356d
df\”,\“parentId\”:\“d89715599a2294301895869cc38aaf616640d716
66becaad2288f6539c0205af\”,\“name\”:\“camera
1\”,\“manufacturer\”:\“ExacqVision\”,\“model\”:\“ExacqVision-
Camera\”,\“ipAddress\”:null,\“macAddress\”:null,\“category\”:null,
\“subCategory\”:\“ExacqVision
Camera\”,\“status\”:\“success\”,\“comments\”:null,\“publicKey\”:\“\
”,\“subDevices\”:[ ],\“id\”:null,\“account\”:null,\“classType\”:\“Scan
nerResponseModel\”,\“idProperty\”:\“Id\”}],\“id\”:null,\“account\”:
null,\“classType\”:\“ScannerResponseModel\”,\“idProperty\”:\“Id\”
}]”,
    “assetIds”: [
      “b1e1f4d4-39a5-4e1f-8ad9-b5e92b7c89e9”
    ],
    “failures”: null,
    “assetType”: “JCI.ScannerServer.1.0.0”,
    “assetNames”: [
      “Scanner”
    ]
```

As shown in the above example, the discoveryType is “registration” indicating the even is a registration even. Data for one or more subdeviceIds can be provided in response to the registration request. In some embodiments, the registration request includes the requested subdeviceIds and the response provides data for the requested subdeviceIds. The subdeviceIds may include some or all of the systemIds or systemIds identified in the deep scan response. For example, the subDeviceId
“d89715599a2294301895869cc38aaf616640d71666becaad2288f6539c0205af” corresponds with the Exacq Vision-Server, the subDeviceId
“Ofa84dbb95f9fffa55d6f4b44b62d37c3c24dbc4855eb678ccd594a8b3356ddf” corresponds with the “camera 1” and the subDeviceId
“14a1cb0e7557d37591c9800bed64d64e3eda399481440f616acaa4bad3aflfle” corresponds with the “Dahua DH-PTZ12248V-IRB-N.” In the message field of the response, the details of just the assets such as the devices (i.e., Exacq Vision-Server) or subdevices (i.e., camera 1, Dahua DH-PTZ12248V-IRB-N) requested are included. Other devices within the subsystem as identified in the deep scan response but not on the list of the subset of the identified one or more security devices in the asset hierarchy to be registered are not included in the response.

As described above, the asset data can comprise device data (e.g., online status, firmware version, software version, model, serial number, etc.), telemetry data (, disk space, video recording status, tamper status, or license expiration), or any other type of data obtainable from the one or more identified security devices (i.e., assets). The connector (asset registration) 222c can encrypt and store the user credentials from the login request, URLs, and Device IDs to build the asset hierarchy when the container restarts in container volume 223 (step 428). In some embodiments, the container volume 223 is contained within the memory 212 of edge gateway 202. In other embodiments, the container volume 223 is contained external to the edge gateway 202, such as for example in the cloud platform 250. The connector (asset registration) 222c can also update the asset information in the in-memory DB 225 (step 430).

Process 400 can be updated the plurality of identified subsystems and the one or more identified security devices within each subsystem. Process 400 is shown to include the connector (login) 222a calling the login API using the API services 227 (step 432). In some embodiments, step 432 is the same or similar to step 406. In some embodiments, step 432 includes a login request for different subsystem types using different APIs than step 406. The API services 227 can return updated login data to the connector (login) 222a (step 434). The connector 222a can provide the updated login data to the container volume 223 for storage (step 436). The connector (deep scan) 222b can call the deep scan API using API services 227 (step 438). In some embodiments, step 438 is the same or similar to step 414. The API services 227 returned the updated scan data to the connector (deep scan) 222b (step 440). The updated scan data can include the identified plurality of security subsystems 256 and the one or more identified security devices in the plurality of security subsystems 256. The connector (deep scan) 222b can update the asset hierarchy stored in the in-memory DB 225 (step 441). The message bus 221 can then forward a refresh request to connector (asset registration) 222c (step 444). In some embodiments, refresh request (step 444) is sent prior to step 432 to initiate the entire refresh process. The connector (asset registration) 222c can call the asset registration API using the API services 227 (step 446). The API services 227 can return the updated asset data to the connector (asset registration) 222c (step 448). The connector (deep scan) 222c can update the asset information in the in-memory DB 225 with the updated asset data (step 450). The in-memory DB 225 then publish changes/new devices found in the refresh (e.g., steps 432-450) to the cloud platform by posting on the message bus 221. In some embodiments, the cloud connector 216 can move the message from the message bus 221 to the cloud platform 250.

During process 400, a given connector such as connector 222b for Exacq may perform one or more API calls to a given subsystem. For example, during step 406 of process 400 the connector 222a may send a GET and POST requests as shown in the example below to access the login endpoint of the subsystem and provide the login credentials to initiate the login process. In the example below, the login process is for a server of the Exacq subsystem.
GetAsyncResponse URL-http://192.168.77.73:8090/v1/login.web?output=json
PostAsyncResponse URL-http://192.168.77.73:8090/v1/login.web
   The connector 222a may also login to a specific device, for example as shown below:
GetAsyncResponse URL-http://192.168.77.73:8090/v1/login.web?s=38c0265c-3617-4136-9598-8b2fddc38a7d&action=notify

In some embodiments, during process 400, such as at step 424 to call an asset, the connector 222c may request login to a device and request a notify action to poll a certain device or group of devices for realtime updates. A connector such as connector 222c may also request a status of a device. Such requests may be similar in structure to the examples below:
GetAsyncResponse URL-http://192.168.77.73:8090/v1/server.web/devices?s=38c0265c-3617-4136-9598-8b2fddc38a7d
GetAsyncResponse URL-http://192.168.77.73:8090/login.web?s=38c0265c-3617-4136-9598-8b2fddc38a7d&action=notify
GetAsyncResponse URL-http://192.168.77.73:8090/v1/status.web?s=38c0265c-3617-4136-9598-8b2fddc38a7d&action=notify

During process 400, such as at step 424, a connector such as connector 222c may also request via the API configuration data and/or status for a given device or system. Such requests may be similar in structure to the examples below, with the first request initiatin the configuration request for a camera in a Exacq system, and the second specifying which camera to retrieve the configuration information for:
GetAsyncResponse URL-http://192.168.77.73:8090/v1/config.web?s=38c0265c-3617-4136-9598-8b2fddc38a7d&output=json
GetAsyncResponse URL-http://192.168.77.73:8090/v1/camera.web?s=38c0265c-3617-4136-9598-8b2fddc38a7d&camera=459008
   The GET request specifying config.web may request the configuration of the one or more devices on the system or subsystem, such as the IP address, the macAddress, etc.

Still during process 400, such as at step 424, a connector such as connector 222c may also request via the API event data from a given device or system. Such requests may be similar in structure to the examples below:
GetAsyncResponse URL-http://192.168.77.73:8090/v1/events.web?s=9fa58860-a395-43bb-816d-99a84590c8ef

In some embodiments, in response to the data from step 426 or 448 or 452, one or more control actions may be performed to adjust or alter an operation of the security devices. The control actions may include moving a security device (e.g., rotating a camera), changing a state of a security device (e.g., locking/unlocking a door, activating/deactivating a camera, etc.). In some embodiments, the control action may include performing a test on each security device to ensure the security device is functioning correctly. In some embodiments, the control action may include triggering an alarm based on the image or event data received from the subset of security devices. The alarm may operate one or more other security devices. For example, the alarm may trigger doors to close and/or lock, cameras to activate or pan-tilt-zoom to view a certain area, or activate other measures. In some embodiments, the control action may be performed automatically to each of the select subset of security devices or selectively to one or more devices based on received data. For example, the control action may be applied to all subdevices of a given device in a subsystem, or to all devices in a given subsystem itself.

In some embodiments, a control action may also be performed before, during, or after process 400, either after a protocol scan, a deep scan, or a registration request, that may adjust the function of future protocol scans, deep scans, or registration requests. In such embodimenst, the control action may include modifying which subsystems are searched for in a protocol scan, which subsystems a deep scan may be performed on, or which devices in a subsystem are registered or monitored. For example, if after a first protocol scan does not identify the Ccure subsystem in the BMS 200, a second protocol scan in the future may not search for a Ccure subsystem. In some embodiments, a successive protocol scan will not search for a Ccure subsystem until a predetermined amount of time has passed (e.g., a day, a month, etc.) or until a predetermine number n of protocol scans has occurred. In some embodiments, if a protocol scan identifies a subsystem, for example Genetec, the control action may automatically mark that subsystem as being included in the next protocol scan. In some embodiments, it is included in the next n protocol searches. In some embodiments, it is marked as included in the next protocol scans performed within a predetermined amount of time. Similarly, in some embodiments, even if a subsystem is identified, it may include no devices as determined by a deep scan. Accordingly, the control action may automatically remove the subsystem from future protocol scans and/or deep scans considering there are no devices to be discovered. This can increase the speed of scans and reduce the computing power and amount of data necessary to perform a scan. In some embodiments, if a subsystem includes a number of security devices, but none of the security devices in that control system are registered or monitored by a user for example from a registration request as in step 420, than the entire subsystem is removed from future protocol scans and/or device scans. In such embodiments, the scans may be performed only for a desired subset of subsystems/protocols, such as those with at least one device in use or at least being actively monitored.

In some embodiments, the control action includes performing a subsequent protocol scan or deep scan to identify new subsystems or devices that may have been added since the previous scans. In some embodiments, this may include determining an amount of time before performing the successive scans based on the results of the prior scans. For example, if a prior protocol scan (i.e., a subsystem scan as in process 500) identifies a Ccure subsystem but not an Exacq subsystem, the next scan may be automatically performed after a first amount of time (e.g., a day, a week, a month) because the Exacq subsystem may be a preferred or expected subsystem that a system may search for. If the protocol scan instead identifies the Exacq subsystem but not a Ccure subsystem, it may not perform the next scan until after a second amount of time greater than the first amount of time, because the Ccure subsystem may not be a preferred subsystem. Which subsystems are preferred and the amount of time that should elapse before each successive scan based on which subsystems are identified and/or which subsystems are not identified may be determined by a user configuring the BMS 200.

### Subsystem Scan

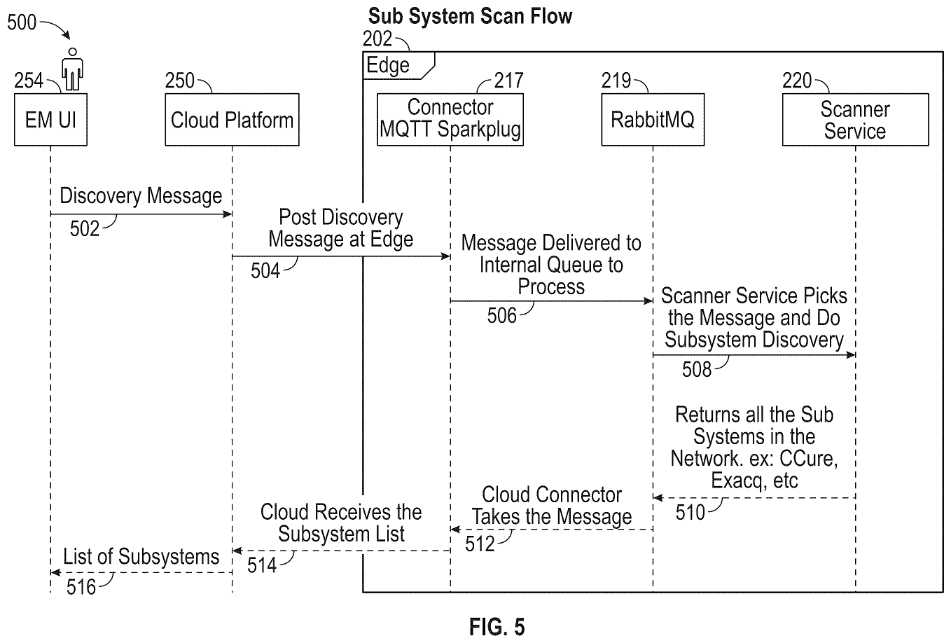

Referring now to FIG. 5, a sequence diagram illustrating a subsystem scan process 500 is shown, according to an exemplary embodiment. Process 500 can be performed by one or more components of the BMS 200 to identify a plurality of security subsystems (e.g., security subsystems 256) on a building network within the BMS 200. For example, process 500 can be performed by the edge gateway 202 and/or various components of cloud platform 250. In some embodiments, the building network is the system bus 266.

Process 500 is shown to include enterprise manager user interface (EM UI) 254 sending a discovery message to cloud platform 250 (step 502). In some embodiments, the discovery message is initiated by a user to initiate the subsystem scan. In some embodiments, the discovery message is sent periodically based on a trigger to periodically update the list of identified subsystems in the BMS 200. The trigger can be a timer, event schedule, manual device addition, reboot, etc. The cloud platform 250 can then most the discovery message to the edge gateway 202, which passes it to the MQTT SparkPlug connector 217 (step 504). While shown as the MQTT SparkPlug connector 217, it should be understood that the MQTT SparkPlug connector 217 can be hosted by the cloud connector 216. The MQTT SparkPlug connector 217 can deliver the message to the internal queue of RabbitMQ 219 to process. MQTT SparkPlug connector 217 and RabbitMQ 219 can act as messaging services to receive and send messages across the edge gateway 202 and to the cloud platform 250. In some embodiments, the MQTT SparkPlug connector 217 and RabbitMQ 219 are process or units within the edge gateway 202, and in some embodiments within the cloud connector 216. The RabbitMQ 219 can communicate with the scanner 220 to pick the message and do subsystem discovery. As described above, subsystem discovery includes scanning the BMS 200 for any security subsystems 256 which are present. To discovery the present subsystems, multiple subsystem scans are performed, each using a different one of the plurality of security protocols 268. Each individual subsystem scan (per protocol) is conducted using a plurality of protocol-specific subsystem criteria. The protocol-specific subsystem criteria can include one or more identifying features corresponding to a particular type of subsystem (e.g., Genentee, Ccure, Exacq, etc.). The individual subsystem scan can include providing a command and/or analyzing a response to search for the protocol-specific subsystem criteria. In some embodiments, this includes providing commands or analyzing response for a plurality of protocol-specific subsystem criteria, one for each type of subsystem to be searched for. Accordingly, subsystem discovery in step 508 can include performing a plurality of subsystem scans according to discrete security protocols 268, and each of the plurality of subsystem scans can itself include performing a plurality of checks for protocol-specific subsystem criteria corresponding to each type of subsystem to be searched for. For example, when a first subsystem scan has searched for the protocol-specific subsystem criteria corresponding to the Genetec-type subsystem, the first subsystem scan then proceeds to search for the protocol specific subsystem criteria corresponding to the another subsystem type, such as the Ccure-type subsystem. This process continues until the protocol-specific subsystem criteria for each type of subsystem desired is searched for. Then, a second subsystem scan according to a different protocol proceeds, with the second subsystem scan also searching for a plurality of protocol-specific subsystem criteria. In this manner, specific criteria based on each type of subsystem and each security protocol are searched for to identify the security subsystems 256. The identifying features of the protocol-specific subsystem criteria can include a unique network port to post the command on and/or an identifying string of characters. Still in other embodiments the identifying feature can be a response time, a response format, a file type, or other identifying characteristics of the security subsystems 256.

Process 500 is shown to include the scanner service (e.g., scanner 220) returning all subsystems in the network (e.g., BMS 200) to the RabbitMQ 219 (step 510). The returned subsystems are those subsystems who protocol-specific subsystem criteria were found in the plurality of subsystems scans. A protocol-specific subsystem criteria need only be found once to indicate a subsystem is present of that type. The RabbitMQ 219 then provides the message via the MQTT SparkPlug connector 217 to the cloud connector, such as for example cloud connector 216 (step 512). The MQTT SparkPlug connector 217 passes the subsystem list to the cloud platform 250 (step 514). The cloud platform 250 can then provide the subsystem list of the identified security subsystems to the EM UI 254.

### Device Scan

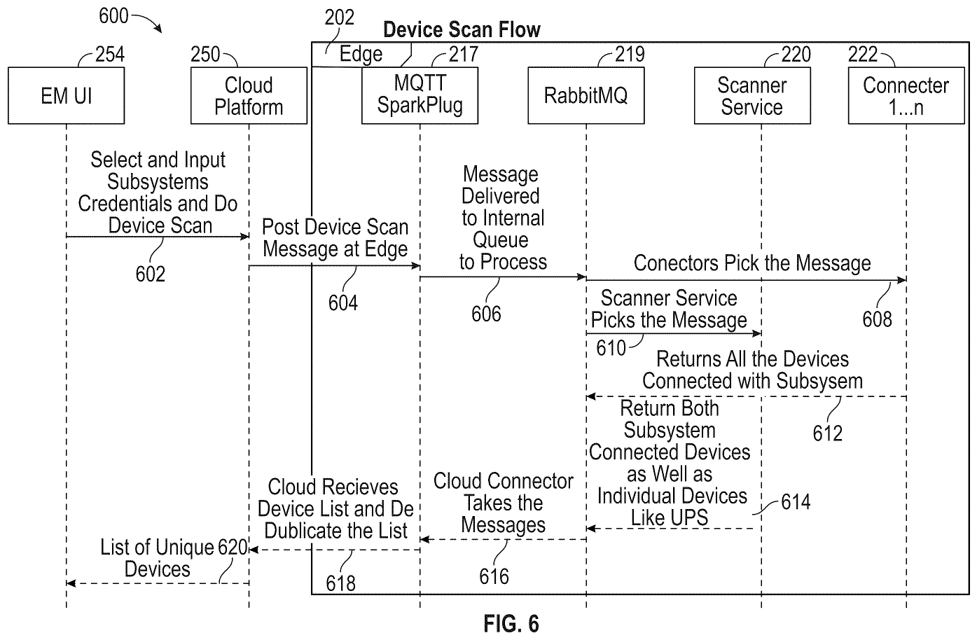

Referring now to FIG. 6, a sequence diagram illustrating a device scan process 600 is shown, according to an exemplary embodiment. Process 600 can be performed by one or more components of the BMS 200 to identify one or more security devices within each of the plurality of security subsystems listed in step 516 of process 500. For example, process 600 can be performed by the edge gateway 202 and/or various components of cloud platform 250. In some embodiments, the building network is the system bus 266.

Process 600 is shown to include the EM UI 254 to select and input subsystem credential for a device scan and provide the same to the cloud platform 250 (step 602). In some embodiments, a user may select to only perform a device scan on a subsystem of the identified security subsystems 256. In other embodiments, a device scan according to process 600 can be performed on each security subsystems 256 that is identified. The cloud platform 250 posts the device scan message onto the edge gateway 202 via the MQTT SparkPlug connector 217 (step 604). The MQTT SparkPlug connector 217 delivers the message to the internal queue of RabbitMQ 219 to process (step 606). The RabbitMQ 219 sends the message to the connectors 222 and allows the connector to pick the message (step 608) and also allows the scanner 220 to pick the message (step 610). The connectors 222 can include specific APIs corresponding to the identified subsystem types that are being searched. For example, if in process 500 CCure, Exacq, Genetec, Kantech, and VideoEdge subsystems were searched for but only CCure and Exacq subsystems were identified, the connectors 222 for only the CCure and Exacq subsystems would be used. This saves network bandwidth and computing power, as otherwise the connectors for the other types of security subsystems would need to be searched. However, the initial subsystem scan (e.g., process 500) reduces the candidate subsystem types that must be searched.

The connectors 222 identify devices within each of the identified subsystems and return all the identified devices connected with the subsystems to the RabbitMQ 219 (step 612). Each type of subsystem can have its own method for identifying devices within it according to its own API. The connectors 222 operate to request the device list from each subsystem and provide the received device lists to back to the edge gateway 202. The scanner 220 also returns to the RabbitMQ 219 both subsystem connected devices as well as individual devices (step 614). For example, individual devices such as a UPS may not belong to any identified type of subsystem and yet still present themselves on the BMS 200 network. The scanner 220 can identify the individual devices as well as the subsystem connected devices. The RabbitMQ 219 passes the message to the MQTT SparkPlug connector 217 using the cloud connector 216 (step 616). The MQTT SparkPlug connector 217 provides the device list and a duplicate list to the cloud platform 250 (step 618). In some embodiments, one or more of the security devices (e.g., devices 280-292) can be compatible with more than one security protocol 268 and/or more than one type of subsystem. Accordingly, the same security device may be identified in multiple device scans and therefore be duplicated on the device list. The edge gateway 202 can identify any duplicate devices in the device list and provide them in a duplicate device list. The cloud platform 250 can generate a list of unique devices based on the device list and the duplicate device list and pass the list of unique devices to the EM UI 254. The list of unique devices includes the one or more identified security devices identified across the plurality of security protocols 268 and security subsystems 256 while correcting for duplicates that may have occurred because multiple scans were performed on the same BMS 200. The cloud platform 250 can then pass the list of unique devices to the EM UI 254 (step 620).

### Device Monitor

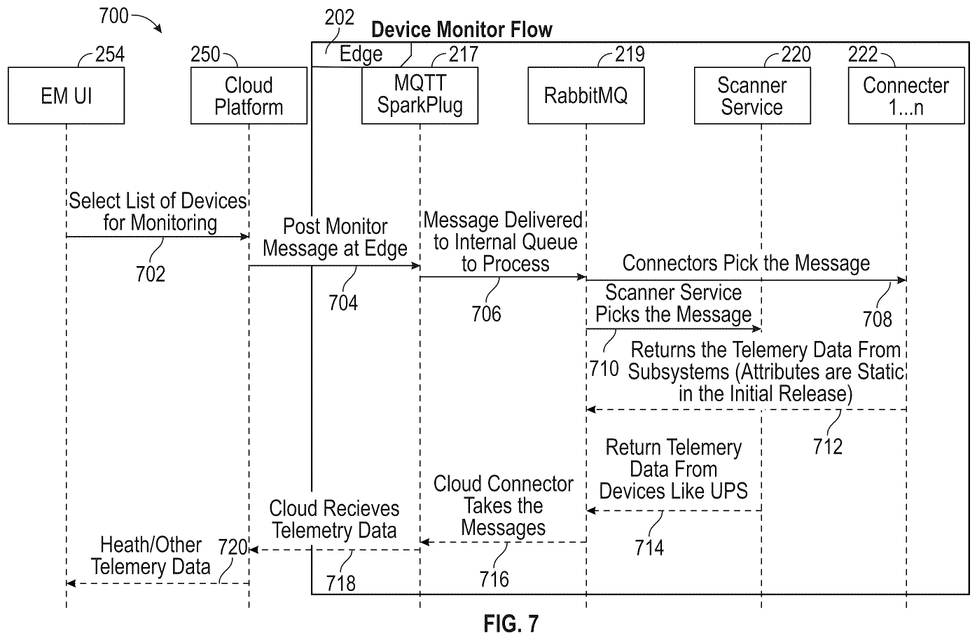

Referring now to FIG. 7, a sequence diagram illustrating a device monitoring process 700 is shown, according to an exemplary embodiment. Process 700 can be performed by one or more components of the BMS 200 to subscribe to, retrieve, and otherwise monitor a selected subset of the one or more security devices identified in the list of unique devices in step 620 of process 600. For example, process 700 can be performed by the edge gateway 202 and/or various components of cloud platform 250. In some embodiments, the building network is the system bus 266.

Process 600 is shown to include the EM UI 254 providing a select list of devices for monitoring to the cloud platform 250. As described herein, a user interact with the EM UI 254 to select a subset of security devices from the list of unique devices provided in step 620 of process 600 for monitoring. The cloud platform 250 posts the monitor message the edge gateway 202 on the MQTT SparkPlug connector 217 (step 704). The MQTT SparkPlug connector 217 delivers the message to the internal quote of RabbitMQ 219 for processing. The RabbitMQ 219 then passes the message to the connectors 222 (step 708). The RabbitMQ 219 also has the scanner 220 pick the message (step 710). The connectors 222 (those associated with the types of subsystems corresponding to the selected subset of security devices) return the telemetry data from the subsystems for the selected devices to the RabbitMQ 219 (step 712). In some embodiments the telemetry data is static data, however in other embodiments the telemetry data can be dynamic data. The scanner 220 also returns the telemetry data from any individual devices which might not be a part of any identified subsystem to the RabbitMQ 219. The RabbitMQ 219 passes the message to the MQTT SparkPlug connector 217 using the cloud connector 216 (step 716). The MQTT SparkPlug connector 217 passes the message from the edge gateway 202 to the cloud platform 250 (step 718). The cloud platform 250 then provides the health or other telemetry data that is received to the EM UI 254.

In some embodiments, based on the data from the subset of security devices, one or more control actions may be performed to adjust or alter an operation of the security devices as discussed above with reference to process 400.

### NMAP Protocol Scan Example

Referring now to FIG. 8, a flow diagram illustrating an NMAP protocol subsystem scan process 800 is shown, according to an exemplary embodiment. Process 800 can be performed by one or more components of the BMS 200 to identify the security subsystems 256 present in the BMS 200 which use or are compatible with the NMAP security protocol. For example, process 800 can be performed by the edge gateway 202 and/or various components of cloud platform 250. In some embodiments, the building network is the system bus 266. Process 800 can be an example of the process 500 subsystem scan, specifically an example illustrating the protocol-specific subsystem criteria for the NMAP security protocol.

Process 800 is shown to include process commands (step 801). Step 801 can lead to getting commands from a cloud, such as cloud platform 250 (step 802). The commands from step 802 can include a start command to trigger various processes (step 803). The processes include a login operation (step 804), a normal scan (step 806), a deep scan (step 834), and asset registration (step 836). At step 804 the login process uses one or more connectors 222 to login to the respective APIs for one or more subsystem types. For example, the subsystems tpyes are shown as CCure, Exaxq, and others. The login at step 804 can be the same or similar to steps 402-408 of process 400 and to the subsystem scan process 500 shown in FIG. 5. It should be understood that while in FIG. 8 the normal scan is shown as separate from the login process, in some embodiments, the normal scan is a part of the login process, and both the normal scan and login process can both refer to the same process of identifying subsystems with the BMS 200.

The example discovery process shown in process 800 initiates a normal scan (step 806). The normal scan, otherwise referred to herein as a subsystem scan, can include performing a scan for each of a plurality of security protocols (e.g., security protocols 268), shown as SNMP scan 808, Onvif Scan 810, SSDP scan 812, and NMAP scan 814. While process 800 illustrates the steps for the NMAP scan 814, each of the protocol-specific subsystem scans are performed. With each protocol-specific subsystem scan there are also a plurality of checks for each type of subsystem which is to be searched for. These are shown as a Ccure check (step 816), an Exacq check (step 818), a Genetec check (step 820), a Kantech check (step 822) and a VideoEdge check (step 824). Each check includes checking the BMS 200 for a protocol-specific subsystem criteria associated with the given subsystem type. For example, the protocol-specific subsystem criteria for the Ccure subsystem using the NMAP protocol is to provide a command on network Port 443 and to check the response for “victorwebservice” in the title (step 816), and the protocol-specific subsystem criteria for the Exacq subsystem using the NMAP protocol is to provide a command on network Port 443 and to check the response for if the Exacq service is running (step 818). Each of the other protocol scans (i.e., SNMP scan 808, Onvif scan 810, and SSDP scan 812) include their own protocol-specific subsystem criteria for each type of subsystem. The protocol-specific subsystem scans at steps 808-814 can be the same or similar to step 508 of process 500.

Process 800 is shown to include computing the NMAP scan results (step 826). This includes checking particular xml node's values, filtering security subsystem types and adding a result row in the response model (e.g., the model stored in in-memory DB 225). The protocol scan results for each security protocol (e.g., steps 808-814), including checks for subsystems 816-824 in each protocol scan, are then consolidated (step 828). In some embodiments, the results may include duplicate entries as some subsystems or security devices may be compatible with multiple protocols. The results can be screened and duplicates removed to provide the consolidated results with unique results only. The results can be sent to the cloud (step 830). In some embodiments, the cloud can be the cloud platform 250. The process 800 can then end (step 832).

The deep scan (e.g., step 834) of process 800 can be the same or similar to steps 410-418. Deep scan (step 834) also corresponds with the device scan process 600 shown in FIG. 6. It should be understood that device scan and deep scan both refer to the same process of identifying specific devices within each of the previously identified security subsystem 256.

### Security Device Categorization

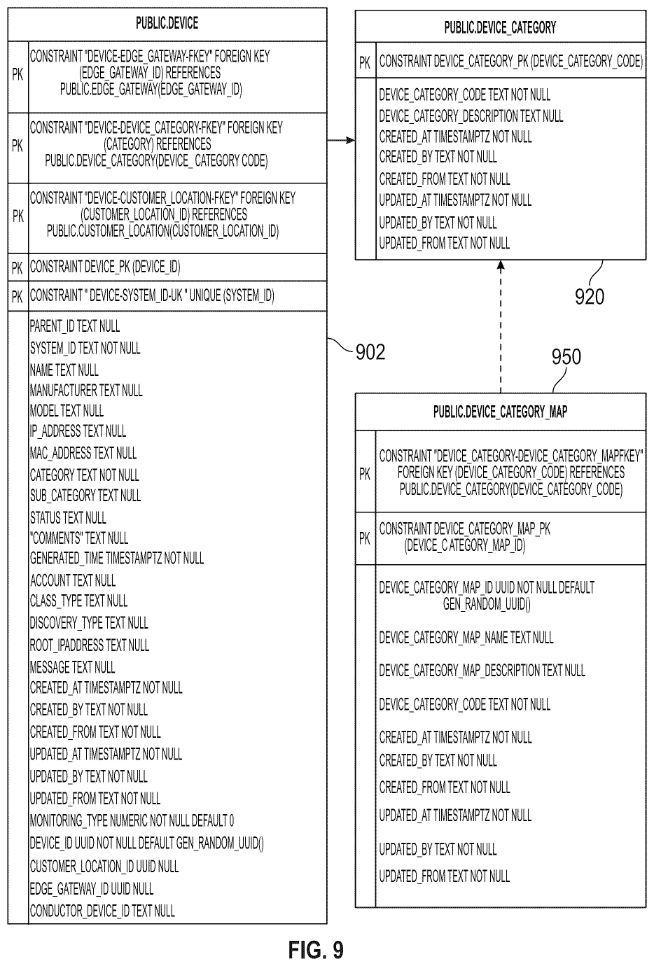

Referring now to FIG. 9, edge gateway 202 can assign each of the identified security devices (e.g., from the device scan process 600) to a category. A security device, shown as public device 902, includes a plurality of data. Based on the data within the security device-which can be retrieved according to the device monitoring process 700—the edge gateway 202 can assign the public device 902 to a device category 920. The public device 902 is first given a ‘subcategory’ based on its one or more pieces of device data, such as its model. The subcateorgy may include a reference to the subsystem the public device 902 operates within, for example “CCure Door” or “CCure Reader.” In some embodiments, the cloud platform 250 further includes a public device category map which maps and/or assigns the public device 902 from based on device data such as a model to technology category (i.e. “Access”, “Video”).

### Configuration of Exemplary Embodiments

The construction and arrangement of the systems and methods as shown in the various exemplary embodiments are illustrative only. For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for onboarding security devices coupled to a building network in a building management system, the method comprising:
transmitting a plurality of commands on the building network, each command comprising protocol-specific subsystem criteria for a corresponding security subsystem type of a plurality of security subsystem types;
receiving a plurality of responses to the plurality of commands from the security devices via the building network;
identifying a plurality of security subsystems on the building network based on whether the plurality of responses contain identifying strings specified by the protocol-specific subsystem criteria for the plurality of security subsystem types;
generating an asset hierarchy comprising the plurality of security subsystems identified on the building network and the security devices within each identified security subsystem; and
onboarding the security devices within each identified security subsystem.

2. The method of claim 1, further comprising operating the security devices identified within each identified security subsystem using the protocol-specific subsystem criteria.

3. The method of claim 1, wherein the protocol-specific subsystem criteria comprises a unique network port and an identifying string for corresponding security subsystem type.

4. The method of claim 1, wherein each command is transmitted on a network port identified in the protocol-specific subsystem criteria.

5. The method of claim 1, further comprising identifying a subset of the security devices within each identified security subsystem and obtaining device data for the security devices and providing the device to a data platform.

6. The method of claim 5, wherein the data platform is a cloud-based data platform.

7. The method of claim 5, wherein the subset is identified based on a status of the security devices provided in the plurality of responses.

8. The method of claim 5, identifying the subset of the security devices within each identified security subsystem comprises receiving a selection from a user comprising the subset.

9. The method of claim 1, wherein at least one of the plurality of security subsystem types corresponds to at least one of a plurality of security protocols, wherein the plurality of security protocols comprises at least one of SNMP, ONVIF, SSDP, NMAP or WS-Discovery.

10. The method of claim 1, wherein the protocol-specific subsystem criteria are obtained from a data platform.

11. The method of claim 1, wherein the plurality of subsystem types comprises at least one of a Ccure, Exacq, Genetec, Kantech, or VideoEdge type.

12. The method of claim 1, wherein generating the asset hierarchy comprises:
performing a device scan for each of the plurality of security subsystems identified on the building network, wherein each device scan comprises:
selecting, from a plurality of connectors, at least one connector associated with the identified security subsystem;
scanning, using the selected connector, the identified subsystem for one or more security devices connected with the identified security subsystem; and
generating, a device scan response including the one or more security devices and the associated identified security subsystem.

13. The method of claim 12, further comprising determining if the device scan response includes any duplicate security devices in the one or more security devices and removing the duplicate security devices from the device scan response.

14. The method of claim 12, further comprising assigning the security devices within at least one identified security subsystem to at least one of a plurality of device categories based on the device scan response.

15. The method of claim 12, wherein the device scan response comprises at least one of an online status, firmware version, software version, model, serial number, disk space, video recording status, tamper status, or license expiration for at least one of the one or more security devices.

16. A building management system, comprising:
a communications bus;
a plurality of subsystems coupled to the communications bus and configured to communicate on the communications bus, wherein the plurality of subsystems each comprise one or more security devices configured to monitor a state or condition of a building;
a cloud platform communicably coupled to the communications bus;
a first device coupled to the communications bus comprising a processing circuit comprising one or more memory devices coupled to one or more processors, the one or more memory devices configured to store instructions thereon that, when executed by the one or more processors, cause the one or more processors to:
transmit a plurality of commands on the communications bus, each command comprising protocol-specific subsystem criteria for a corresponding subsystem type of a plurality of subsystem types;
receive a plurality of responses to the plurality of commands from the plurality of subsystems via the communications bus;
identify subsystem type from the plurality of subsystem types for each of the plurality of subsystems based on whether the plurality of responses contain identifying strings specified by the protocol-specific subsystem criteria for the plurality of security subsystem types;
generate an asset hierarchy comprising the plurality of security subsystems identified o and the one or more security devices within each identified security subsystem; and
onboard the security devices within each identified security subsystem.

17. The building management system of claim 16, wherein at least one of the plurality of subsystems uses at least one of a plurality of security protocols, wherein the plurality of security protocols comprises at least one of SNMP, ONVIF, SSDP, NMAP or WS-Discovery.

18. The building management system of claim 16, wherein the protocol-specific subsystem criteria comprises a unique network port and the identifying string.

19. The building management system of claim 16, wherein each command is transmitted on a network port identified in the protocol-specific subsystem criteria.

20. The building management system of claim 16, further comprising instructions that, when executed by the one or more processors, cause the one or more processors to:
identify a subset of the one or more security devices within each identified security subsystem;
obtain device data for the one or more security devices; and
provide the device to a data platform.
